(19) United States
(12) Patent Application Publication
(10) Pub. No.: US 2024/0230932 A9
(43) Pub. Date: Jul. 11, 2024

(54) RADIATION DETECTOR MODULE INCLUDING APPLICATION SPECIFIC INTEGRATED CIRCUIT WITH THROUGH-SUBSTRATE VIAS

(71) Applicant: REDLEN TECHNOLOGIES, INC., Saanichton (CA)

(72) Inventors: Michael AYUKAWA, Victoria (CA); Krzysztof INIEWSKI, Port Moody (CA)

(21) Appl. No.: 18/468,891

(22) Filed: Sep. 18, 2023

Related U.S. Application Data
(60) Provisional application No. 63/380,769, filed on Oct. 25, 2022.

(51) Int. Cl. G01T 1/24; G01T 1/175; G01T 1/29

(52) U.S. Cl. CPC G01T 1/241; G01T 1/175; G01T 1/243; G01T 1/244; G01T 1/247; G01T 1/2985

(57) ABSTRACT

A radiation detector unit includes at least one radiation sensor having pixel detectors that generate event detection signals in response to photon interaction events, an application specific integrated circuit (ASIC) including circuit components on a substrate, the at least one radiation sensor mounted over the application specific integrated circuit via a plurality of bonding material portions such that event detection signals generated in each of the pixel detectors of the at least one radiation sensor are received at a respective pixel region of the ASIC, and the circuit components of the ASIC convert the event detection signals received at each of the pixel regions of the ASIC to digital detection signals, and a carrier board underlying the ASIC, where the ASIC includes a plurality of through-substrate vias (TSVs) electrically coupling the ASIC to the carrier board, each of the TSVs underlying an active pixel detector of the at least one radiation sensor.

### FIELD

The present disclosure relates generally to radiation detectors, and more specifically to a radiation detector module including one or more radiation sensors mounted to an application specific integrated circuit including a plurality of through-substrate vias.

### BACKGROUND

Room temperature pixelated radiation detectors made of semiconductors, such as cadmium zinc telluride (Cd₁₋ₓZnₓTe where 0<x<1, or “CZT”), are gaining popularity for use in medical and non-medical imaging. These applications use the high energy resolution and sensitivity of the radiation detectors.

### SUMMARY

According to an aspect of the present disclosure, a radiation detector unit includes at least one radiation sensor having a continuous array of active pixel detectors that generate event detection signals in response to photon interaction events occurring within the pixel detectors, an application specific integrated circuit including circuit components on a substrate, the at least one radiation sensor mounted over a front surface of the application specific integrated circuit via a plurality of bonding material portions such that event detection signals generated in each of the active pixel detectors of the at least one radiation sensor are received at a respective pixel region of the application specific integrated circuit, and the circuit components of the application specific integrated circuit are configured convert the event detection signals received at each of the pixel regions of the application specific integrated circuit to digital detection signals, and a carrier board underlying the application specific integrated circuit, where the application specific integrated circuit includes a plurality of through-substrate vias extending through the application specific integrated circuit and electrically coupling the application specific integrated circuit to the carrier board, and each of the through-substrate vias of the application specific integrated circuit underlies an active pixel detector of the at least one radiation sensor.

Further embodiments include detector arrays including a plurality of the above-described radiation detector units, where the radiation sensors of the plurality of detector radiation detector units form a continuous detector surface of the detector array.

Further embodiments include X-ray imaging systems including a radiation source configured to emit an X-ray beam, and a detector array including a plurality of the above-described radiation detector units that are configured to receive the X-ray beam from the radiation source through an intervening space configured to contain an object therein.

### BRIEF DESCRIPTION OF THE DRAWINGS

FIG. 1A is a functional block diagram of an X-ray imaging system in accordance with various embodiments of the present disclosure.

FIG. 1B is a schematically illustration of an application specific integrated circuit (ASIC) configured to count X-ray photons detected in each pixel detector within a set of energy bins according to various embodiments of the present disclosure.

FIG. 2 is a perspective view of a detector array for a computed tomography (CT) X-ray imaging system according to various embodiment of the present disclosure.

FIG. 3A is a vertical cross-sectional view of a radiation detector unit according to an embodiment of the present disclosure.

FIG. 3B is a plan view illustrating the front side of the application specific integrated circuit (ASIC) of the radiation detector unit of FIG. 3A.

FIG. 4A is a vertical cross-section view of an alternative configuration of a radiation detector unit according to an embodiment of the present disclosure.

FIG. 4B is a plan view of the ASIC of the radiation detector unit of FIG. 4A.

FIG. 5 is a perspective view of a detector module including a plurality of radiation detector units mounted to frame bar according to an embodiment of the present disclosure.

FIG. 6A is a vertical cross-section view of an alternative configuration of a radiation detector unit according to an embodiment of the present disclosure.

FIG. 6B is a side elevation view of a detector module including a plurality of radiation detector units of FIG. 6A according to an embodiment of the present disclosure.

FIG. 7A is a vertical cross-section view of a radiation detector unit including an anti-scatter grid (ASG) disposed over the front side of the radiation sensor according to various embodiments of the present disclosure.

FIG. 7B is a top view schematically illustrating a one-dimensional ASG over the front side of the radiation detector unit of FIG. 7A.

FIG. 7C is a top view schematically illustrating a two-dimensional ASG over the front side of the radiation detector unit of FIG. 7A.

FIG. 8A is a top view of a pixel region of An ASIC illustrating a layout of a contact region and a through-substrate via (TSV) according to an embodiment of the present disclosure.

FIG. 8B is a top view of a pixel region of An ASIC illustrating an alternative layout of a pixel region of An ASIC including a contact region and a pair of TSVs according to an embodiment of the present disclosure.

FIG. 8C is a top view of a pixel region of An ASIC illustrating an alternative layout of a pixel region of An ASIC including a contact region and four TSVs according to an embodiment of the present disclosure.

FIG. 9A is a vertical cross-section view of a radiation detector unit including redundant TSVs extending through the ASIC according to an embodiment of the present disclosure.

FIG. 9B is a vertical cross-section view of a radiation detector unit illustrating an arrangement of TSVs carrying different types of signals according to an embodiment of the present disclosure.

FIG. 10A is a top view of a pixel region of An ASIC illustrating a layout of read-out circuitry according to an embodiment of the present disclosure.

FIG. 10B is a top view of a pixel region of An ASIC illustrating an alternative layout of read-out circuitry according to an embodiment of the present disclosure.

FIG. 10C is a top view of a pixel region of An ASIC illustrating yet another alternative layout of read-out circuitry according to an embodiment of the present disclosure.

FIG. 11A is a top view of a pixel region of An ASIC illustrating a layout of read-out circuitry including low voltage differential signaling (LVDS) circuitry according to an embodiment of the present disclosure.

FIG. 11B is a top view of a portion of An ASIC including three pixel regions including one pixel region having LVDS circuitry according to an embodiment of the present disclosure.

FIG. 11C is a circuit diagram schematically illustrating a transmitter and receiver that may be used for transmitting data from An ASIC to a carrier board according to an embodiment of the present disclosure.

FIG. 12 is a vertical cross-section view of a radiation detector unit that includes a redistribution layer over the front surface of the ASIC according to an embodiment of the present disclosure.

### DETAILED DESCRIPTION

Embodiments of the present disclosure provide radiation detector readout circuits, radiation detector units and radiation detector modules including radiation detector readout circuits, and detector arrays formed by assembling the detector units, and methods of manufacturing the same, the various aspects of which are described herein with reference to the drawings.

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims. Any reference to claim elements in the singular, for example, using the articles “a,” “an,” or “the” is not to be construed as limiting the element to the singular. The terms “example,” “exemplary,” or any term of the like are used herein to mean serving as an example, instance, or illustration. Any implementation described herein as an “example” is not necessarily to be construed as preferred or advantageous over another implementation. The drawings are not drawn to scale. Multiple instances of an element may be duplicated where a single instance of the element is illustrated, unless absence of duplication of elements is expressly described or clearly indicated otherwise.

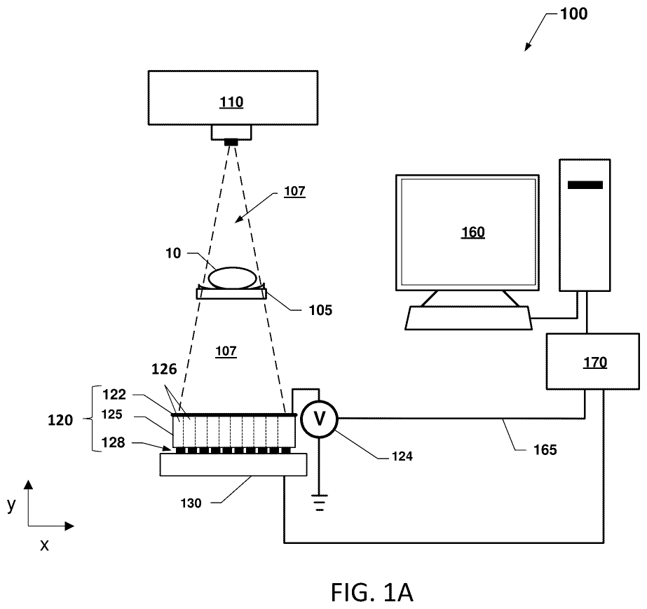

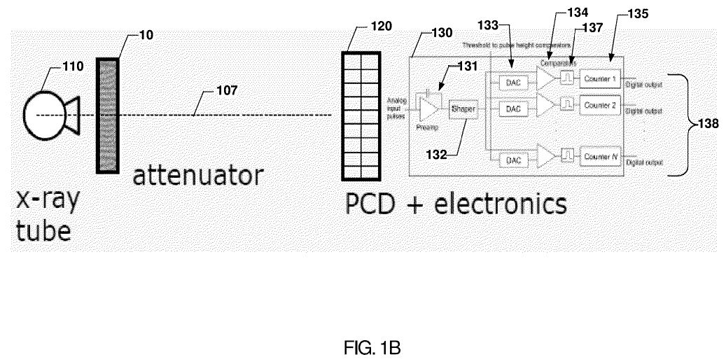

FIG. 1A is a functional block diagram of an X-ray imaging system 100 in accordance with various embodiments. The X-ray imaging system 100 may include an X-ray source 110 (i.e., a source of ionizing radiation), and an energy discriminating photon counting radiation detector 120. The X-ray imaging system 100 may additionally include a patient support structure 105, such as a table or frame, which may rest on the floor and may support an object 10 to be scanned. In some embodiments, the object 10 may be a biologic subject (i.e., a human or animal patient). The support structure 105 may be stationary (i.e., non-moving) or may be configured to move relative to other elements of the X-ray imaging system 100, such as the X-ray source.

The X-ray source 110 is typically mounted to a gantry and may move or remain stationary relative to the object 10. The X-ray source 110 is configured to deliver ionizing radiation to the radiation detector 120 by emitting an X-ray beam 107 toward the object 10 and the radiation detector 120. After the X-ray beam 107 is attenuated by the object 10, the beam of radiation 107 is received by the radiation detector 120.

The radiation detector 120 may be controlled by a high voltage bias power supply 124 that selectively creates an electric field between an anode 128 and cathode 122 pair coupled thereto. In one embodiment, the radiation detector 120 includes a plurality of anodes 128 (e.g., one anode per pixel) and one common cathode 122 electrically connected to the power supply 124 and facing the X-ray source 110. The radiation detector 120 may include a detector material 125, such as a semiconductor material disposed between the anode 128 and cathode 122 and thus configured to be exposed to the electrical field therebetween. The semiconductor material may comprise any suitable semiconductor material for detecting X-ray radiation disposed between the anode 128 and cathode 122 and thus configured to be exposed to the electrical field therebetween. In various embodiments, the semiconductor material of the radiation detector 120 may comprise a II-VI semiconductor material, such as cadmium telluride, cadmium zinc telluride (i.e., CdZnTe or “CZT”), cadmium selenide telluride, and cadmium zinc selenide telluride. Other suitable semiconductor materials are within the contemplated scope of disclosure.

A detector application specific integrated circuit (ASIC) 130 (such as a detector readout integrated circuit (ROIC)), may be coupled to the anode(s) 128 of the radiation detectors 120. The detector ASIC 130 may receive signals (e.g., charge or current) from the anode 128(s) and be configured to provide data to and by controlled by a control unit 170. The signals received by the detector ASIC 130 may be in response to photon interaction events occurring within the radiation-sensitive semiconductor material of the detector material 125. Accordingly, the signals received by the detector ASIC 130 may be referred to as “event detection signals.” The radiation detector 120 may be segmented or configured into a large number of small “pixel” detectors 126. In various embodiments, the pixel detectors 126 of the radiation detector 120 and the readout circuit 130 are configured to output data that includes counts of photons detected in each pixel detector in each of a number of energy bins. Thus, radiation detectors 120 of various embodiments provide both two-dimensional detection information regarding where photons were detected, thereby providing image information, and measurements of the energy of the detected X-ray photons. A radiation detector 120 that is capable of measuring the energy of the X-ray photons impinging on the detector 120 may be referred to as an energy-discriminating radiation detector 120.

The control unit 170 may be configured to synchronize the X-ray source 110, the detector ASIC 130, and the high voltage bias power supply 124. The control unit 170 may be coupled to and operated from a computing device 160. Alternatively, the computing device 160 and the control unit 170 may be integrated together as one device.

In some embodiments, the X-ray imaging system 100 may be a computed tomography (CT) imaging system. The CT imaging system 100 may include a gantry (not shown in FIG. 1A), which may include a moving part, such as a circular, rotating frame with the X-ray source 110 mounted on one side and the radiation detector 120 mounted on the other side. The radiation detector 120 may have a curved shape along its long axis (i.e., the x-axis direction in FIG. 1A) such that each of the pixel detectors along the length of the radiation detector may face towards the focal spot of the X-ray source 110. The gantry may also include a stationary (i.e., non-moving) part, such as a support, legs, mounting frame, etc., which rests on the floor and supports the moving part. The X-ray source 110 may emit a fan-shaped or cone-shaped X-ray beam 107 as the X-ray source 110 and the radiation detector 120 rotate on the moving part of the gantry around the object 10 to be scanned. After the X-ray beam 107 is attenuated by the object 10, the X-ray beam 107 is received by the radiation detector 120. The curved shape of the radiation detector 120 may allow the CT imaging system 100 to create a 360° continuous circular ring of the image of the object 10 by rotating the moving part of the gantry around the object 10.

For each complete rotation of the X-ray source 110 and the radiation detector 120 around the object 10, one cross-sectional slice of the object 10 may be acquired. As the X-ray source 110 and the radiation detector 120 continue to rotate, the radiation detector 120 may take numerous snapshots called “views”. Typically, about 1,000 profiles are taken in one rotation of the X-ray source 110 and the radiation detector 120. The X-ray source 110 and the detector 120 may slowly move relative to the patient along a horizontal direction (i.e., into and out of the page in FIG. 1A) so that the detector 120 may capture incremental cross-sectional profiles over a region of interest (ROI) of the object 10, which may include the entire object 10. The data acquired by the radiation detector 120 and output by the ASIC 130 may be passed along to the computing device 160 that may be located remotely from the radiation detector 120 via a connection 165. The connection 165 may be any type of wired or wireless connection. If the connection 165 is a wired connection, the connection 165 may include a slip ring electrical connection between any structure (e.g., gantry) supporting the radiation detector 120 and a stationary support part of the support structure, which supports any part (e.g., a rotating ring). If the connection 165 is a wireless connection, the radiation detector 120 may contain any suitable wireless transceiver to communicate data with another wireless transceiver that is in communication with the computing device 160. The computing device 160 may include processing and imaging applications that analyze each profile obtained by the radiation detector 120, and a full set of profiles may be compiled to form a three-dimensional computed tomographic (CT) reconstruction of the object 10 and/or two-dimensional images of cross-sectional slices of the object 10.

Various alternatives to the design of the X-ray imaging system 100 of FIG. 1A may be employed to practice embodiments of the present disclosure. X-ray imaging systems may be designed in various architectures and configurations. For example, an X-ray imaging system may have a helical architecture. In a helical X-ray imaging scanner, the X-ray source 110 and radiation detector 120 are attached to a freely rotating gantry. During a scan, a table moves the object 10 smoothly through the scanner, or alternatively, the X-ray source 110 and detector 120 may move along the length of the object 10, creating helical path traced out by the X-ray beam. Slip rings may be used to transfer power and/or data on and off the rotating gantry. In other embodiments, the X-ray imaging system may be a tomosynthesis X-ray imaging system. In a tomosynthesis X-ray scanner, the gantry may move in a limited rotation angle (e.g., between 15 degrees and 60 degrees) in order to detect a cross-sectional slice of the object 10. The tomosynthesis X-ray scanner may be able to acquire slices at different depths and with different thicknesses that may be reconstructed via image processing.

FIG. 1B illustrates components of an X-ray imaging system, including components within the detector ASIC 130 configured to count X-ray photons detected in each pixel detector within a set of energy bins. As used herein, the terms “energy bin” and “bin” refer to a particular range of measured photon energies between a minimum energy threshold and a maximum energy threshold. For example, a first bin may refer to counts of photons determined to have an energy greater than a threshold energy (referred to as a trigger threshold, e.g., 20 keV) and less than 40 keV, while a second bin may refer to counts of photons determined to have an energy greater than 40 keV and less than 60 keV, and so forth.

X-rays 107 from an X-ray source (e.g., X-ray tube) 110 may be attenuated by a target (e.g., an object 10, such as a human or animal patient) before interacting with the radiation detector material within the pixelated detector array 120. An X-ray photon interacting (e.g., via the photoelectric effect) with a pixelated radiation detector material generates an electron cloud within the material that is swept by an electric field to the anode electrode 128. The charge gathered on the anode 128 creates a signal (i.e., an above-described event detection signal) that is transmitted to the readout circuit 120 and integrated by a charge sensitive amplifier (CSA) 131. There may be a CSA 131 for each pixel detector (e.g., for each anode 128) within the pixelated X-ray detector 120. The voltage of the CSA output signal may be proportional to the energy of the X-ray photon. The output signal of the CSA may be processed by an analog filter or shaper 132.

The filtered output may be connected to the inputs of a number of analog comparators 134, with each comparator connected to a digital-to-analog converter (DAC) 133 that inputs to the comparator a DAC output voltage that corresponds to the threshold level defining the limits of an energy bin. The detector ASIC 130 may be configured so that after the CSA voltage has stabilized (after the dead time), that voltage may be between two voltage thresholds set by two DACs 133, which determines the output of the comparators 134. Outputs from the comparators 134 may be processed through decision gates 137, with a positive output from a comparator 134 corresponding to a particular energy bin (defined by the DAC output voltages) resulting in a count added to an associated counter 135 for the particular energy bin. Periodically, the counts in each energy bin counter 135 are output as signals 138 to the control unit 170.

The detector array of an X-ray imaging system may include an array of radiation detector elements, referred to herein as pixel detectors. The signals from the pixel detectors may be processed by a pixel detector circuit, which may sort detected photons into energy bins based on the energy of each photon or the voltage generated by the received photon. When an X-ray photon is detected, its energy is determined and the X-ray photon count for its associated energy bin is incremented. For example, if the detected energy of an X-ray photon is 24 kilo-electron-volts (keV), the X-ray photon count for the energy bin of 20-40 keV may be incremented. The number of energy bins may be three or more, such as four to twelve. In an illustrative example, an X-ray photon counting detector may have four energy bins: a first bin for detecting photons having an energy between 20 keV and 40 keV, a second bin for detecting photons having an energy between 40 keV and 60 keV, a third bin for detecting photons having an energy between 60 keV and 90 keV, and a fourth bin for detecting photons having an energy above 90 keV (e.g., between 90 keV and 120 keV). The greater the total number of energy bins, the better the material discrimination. The total number of energy bins and the energy range of each bin may be selectable by a user, such as by adjusting the threshold levels defining the limits of the respective energy bins in the ASIC 130 as shown in FIG. 1B.

In various embodiments, a radiation detector 120 for an X-ray imaging system 100 as described above may include a detector array including a plurality of pixel detectors 126 extending over a continuous two-dimensional (2D) detector array surface. The detector array (which is also known as a detector module system (DMS)) may include a modular configuration including a plurality of detector modules, where each detector module may include at least one radiation sensor (e.g., a detector material 125 including cathode and anode electrode(s) 122, 128 defining pixel detectors 126 as described above), at least one ASIC 130 electrically coupled to the at least one radiation sensor, and a module circuit board. The module circuit board may support transmission of electrical power, control signals, and data signals between the module circuit board and the at least one ASIC 130 and the at least one radiation sensor of the detector module, and may further support transmission of electrical power, control signals, and data signals between the module circuit board and the control unit 170 of the X-ray imaging system 100, other module circuit boards of the detector array, and/or a power supply for the detector array. A plurality of detector modules may be assembled on a common support structure, such as a detector array frame, to form a detector array.

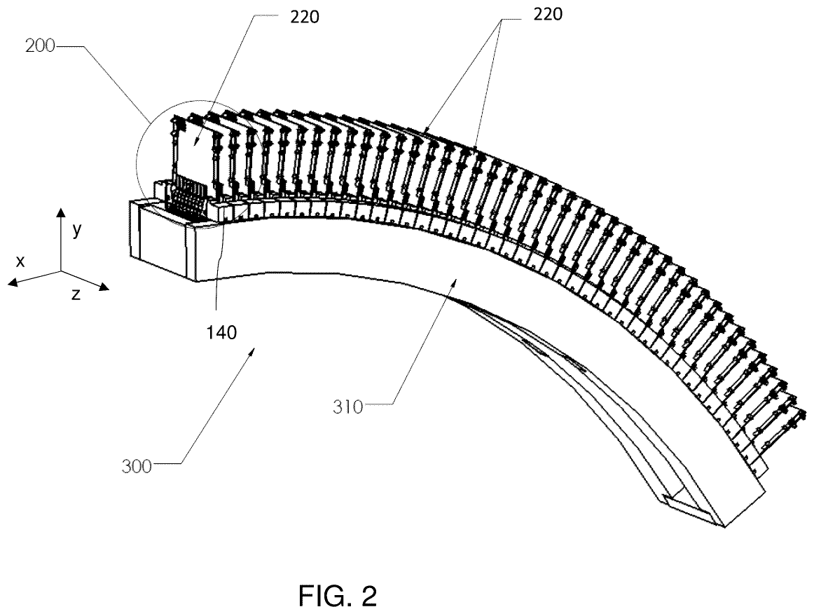

FIG. 2 is a perspective view of a detector array 300 for a computed tomography (CT) X-ray imaging system according to various embodiment of the present disclosure. The detector array 300 in this embodiment includes multiple detector modules 200 mounted on a detector array frame 310. The detector array frame 310 may be configured to provide attachment of a row of detector modules 200 such that physically exposed surfaces of the radiation sensors of the detector modules 200 collectively form a curved detection surface located within a cylindrical surface. The multiple detector modules 200 may be assembled such that radiation sensors attached to neighboring detector modules 200 abut each other, i.e., make direct surface contact with each other and/or include a gap between adjacent radiation sensors that is less than 3 mm, and/or less than 2 mm, and/or less than 1 mm in the x-direction. In some embodiments, the detector modules 200 may be mounted to the detector array frame 310 by attaching frame bars 140 of the detector modules 200 to the detector array frame 310 using suitable mechanical fasteners. The radiation sensors and ASICs 130 of each module 200 may be mounted over a first (i.e., front) surface of the frame bar 140. Each module 200 may also include a module circuit board 220 extending away from a rear surface of the frame bar 140. Major surfaces of the module circuit boards 220 of the detector modules 200 may face each other in the detector array 300.

In some embodiments, each of the detector modules 200 of a detector array 400 may be constructed from a set of radiation detector units, which may also be referred to as “mini-modules” or “submodules.” In some embodiments, each of the radiation detector units may include one or more radiation sensors coupled to a single ASIC 130. The radiation detector units according to various embodiments may be designed to minimize gaps between adjacent pairs of radiation detector units. Thus, a two-dimensional array of four side buttable radiation detector units forming a continuous detector surface may be provided without gaps, or with only minimal gaps, among the radiation detector units.

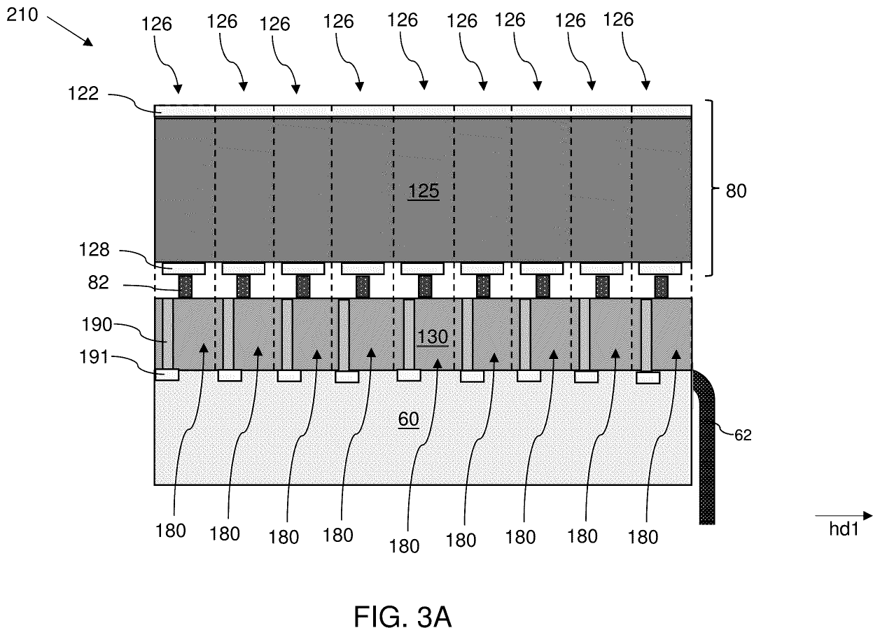

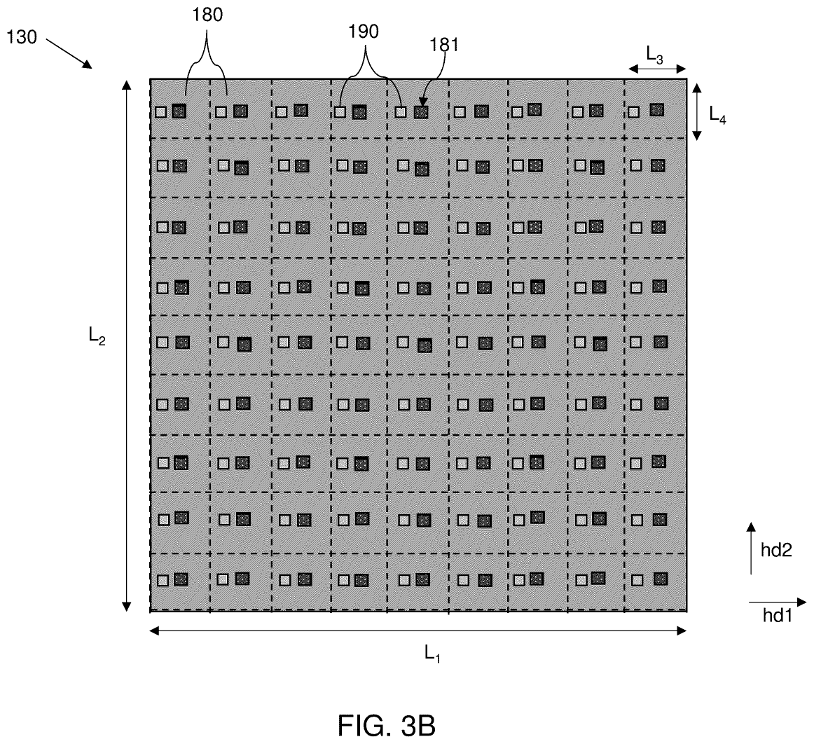

FIG. 3A is a vertical cross-sectional view of a radiation detector unit 210 according to one embodiment of the present disclosure. Referring to FIG. 3A, the radiation detector unit 210 includes a radiation sensor 80 coupled to an ASIC 130. The radiation sensor 80 may include an above-described detector material 125 having at least one cathode electrode 122 on a front side of the radiation sensor 80 and a plurality of anode electrodes 128 on a back side of the radiation sensor 80 defining an array of pixel detectors 126 as described above. As used herein, the “front side” of elements refers to the side that faces the incoming radiation, and the “backside” of elements refers to the side that is the opposite side of the front side.

The radiation sensor 80 may be directly mounted to the front side of the ASIC 130 via a plurality of bonding material portions 82. In other words, the radiation sensor 80 may be mechanically and electrically coupled to the ASIC 130 via the plurality of bonding material portions 82, and no interposer or similar intervening structural component for routing of electrical signals between the radiation sensor 80 and the ASIC 130 is located between the back side of the radiation sensor 80 and the front side of the ASIC 130. Directly mounting the radiation sensor(s) 80 to the front side of the ASIC 130 may provide a significant reduction in input node capacitance as compared to a radiation detector unit that includes an interposer located between the radiation sensor(s) 80 and the ASIC 130. For example, an embodiment radiation detector unit 210 having direct attachment of the radiation sensor(s) 80 to the ASIC 130 may provide an 80% or more reduction in the input node capacitance compared to an equivalent detector unit having an interposer (e.g., 0.2 pF vs. 1.0 pF). This may result in lower power consumption (e.g., 0.2 mW/channel compared to 0.8 mW/channel using an interposer) and lower equivalent noise charge (ENC) (e.g., 250 e− vs, 700 e− using an interposer).

The plurality of bonding material portions 82 may be arranged in an array, such as a rectangular array, having the same periodicity as the periodicity of the anode electrodes 128 on the back side of the radiation sensor 80. Thus, each bonding material portion 82 may electrically couple a respective anode electrode 128 of the radiation sensor 80 to the front side of the ASIC 130. In one non-limiting embodiment, the bonding material portions 82 may be composed of a conductive epoxy. Other suitable bonding materials, such as a low temperature solder material with under bump metallization, may be utilized to mount the radiation sensor 80 to the front side of the ASIC 130.

In various embodiments, the ASIC 130 may include an arrangement of electronic signal sensing channels and supporting logic circuitry in at least one monolithic component. The ASIC 130 may include an arrangement of circuit components (e.g., transistors, such as field effect transistors (FETs), resistors, capacitors, etc.) and associated interconnect structures located on and/or within a single supporting substrate, which may be a semiconductor material substrate (e.g., a silicon substrate). FIG. 3B is a plan view illustrating the front side of the ASIC 130 of the radiation detector unit 210 of FIG. 3A. In various embodiments, the dimensions of the ASIC 130 may generally correspond to the dimensions of the radiation sensor(s) 80 mounted over the front side of the readout circuit 130. In particular, the dimensions, L₁ and L₂, of the ASIC 130 along respective orthogonal horizontal directions hd1 and hd2 may be substantially equal (e.g., within ±4%, such as ±0-2%) to the dimensions of the radiation sensor(s) 80 mounted to the ASIC 130 along the same horizontal directions hd1 and hd2. In the embodiment illustrated in FIGS. 3A and 3B, a single radiation sensor 80 is mounted to the front side of the ASIC 130, although it will be understood that in other embodiments, multiple radiation sensors 80 may be mounted to the front side of the ASIC 130, such that the dimensions, L₁ and L₂, of the ASIC 130 along horizontal directions hd1 and hd2 may be substantially equal to the combined dimensions of the multiple radiation sensors 80 along the same horizontal directions hd1 and hd2. In embodiments in which multiple radiation sensors 80 having identical sizes are mounted to the front side of the ASIC 130, the dimensions L₁ and L₂, of the ASIC 130 may each be an integer multiple of the corresponding dimensions of the radiation sensors 80. The ASIC 130 and each of the radiation sensors 80 mounted thereto may have a rectangular periphery. This may enable any of the four peripheral sides of the radiation detector unit 210 to be abutted against a peripheral side of an adjacent radiation detector unit 210 upon assembly of multiple radiation detector units 210 in a two-dimensional detector array.

In various embodiments, the dimensions L₁ and L₂, of the ASIC 130 may each be greater than about 0.5 cm, such as at least about 1 cm. In some embodiments, the ASIC 130 may have at least one dimension (i.e., L₁ and/or L₂) that is at least about 4 cm, such as 8 cm or more (e.g., 8-16 cm), although greater and lesser dimensions for the ASIC 130 may be utilized.

Referring again to FIGS. 3A and 3B, the radiation sensor 80 may include array of contiguous pixel detectors 126 and the ASIC 130 may include a plurality of pixel regions 180 underlying each of the pixel detectors 126 of the radiation sensor 80, as indicated by the dashed lines in FIGS. 3A and 3B. A bonding material portion 82 may extend between each pixel detector 126 of the radiation sensor 180 and a corresponding pixel region 180 of the ASIC 130. Thus, as shown in FIG. 3B, each pixel region 180 of the ASIC 130 includes a contact region 181 in which a bonding material portion 82 contacts the front side of the ASIC 130. Metal interconnect structures (not shown in FIGS. 3A and 3B) on the front side of the ASIC 130 may electrically couple the contact regions 181 to the various circuit components (e.g., transistors, resistors, capacitors, etc.) of the ASIC 130. Each of the pixel regions 180 of the ASIC 130 may have dimensions, L₃ and L₄ along horizontal directions hd1 and hd2 that are substantially equal (e.g., within ±4%, such as ±0-2%) to the corresponding dimensions of the pixel detector 126 overlying the pixel region 180 of the ASIC 130. In some embodiments, the dimensions L₃ and L₄ of each pixel region 180 may be in a range of 250-500 μm, although greater and lesser dimensions are within the contemplated scope of disclosure. In one non-limiting embodiment, each of the pixel regions 180 of the ASIC 130 may be a 330 μm×330 μm square. In other embodiments, the pixel regions 180 may be rectangular-shaped in which the dimensions L₃ and L₄ are not equal. Each of the contact regions 181 of the pixel regions 180 may have dimensions along horizontal directions hd1 and hd2 that are each greater than about 50 μm, such as between 50 μm and 150 μm (e.g., ˜100 μm). In various embodiments, the plurality of pixel regions 180 may extend continuously over the entire area of the ASIC 130. In the illustrative embodiment shown in FIGS. 3A and 3B, the ASIC 130 includes a 9×9 matrix array of pixel regions 180 extending over the entire area of the ASIC 130, although it will be understood that An ASIC 130 having greater or lesser numbers of pixel regions 180 may be utilized in various embodiments.

Referring again to FIG. 3A, the radiation detector unit 210 may further include a carrier board 60 that is configured to route power supply to the ASIC 130 and to the at least one radiation sensor 80, control signals to the ASIC 130, and data signals (e.g., digital detection signals) generated by the ASIC 130. One or more cables 62, such as a flex cable assembly, may be attached to a respective side of the carrier board 60, and another end of each cable may be connected to a module circuit board 220 as shown in FIG. 2. The carrier board 60 may be a printed circuit board including an insulating substrate and printed interconnection circuits. In various embodiments, the ASIC 130 may be disposed over the carrier board 60 such that the back side of the ASIC 130 may contact the front side of the carrier board 60.

Referring again to FIGS. 3A and 3B, a plurality of through-substrate vias (TSVs) 190 may be provided in the ASIC 130. Each of the TSVs 190 may be located within a pixel region 180 of the ASIC 130. The TSVs 190 may include an electrically conductive material (e.g., a metal material, such as copper) that extends between the front side and the back side of the ASIC 130. In embodiments in which the ASIC 130 may be formed on and/or in a silicon substrate, the TSVs 190 may also be referred to as “through-silicon vias.”

Accordingly, electrical connections between the carrier board 60 and the ASIC 130 may be made through the back side of the ASIC 130 via the plurality of TSVs 190. In particular, each of the TSVs 190 may electrically contact a conductive trace 191 located on the front side of the carrier board 60, as schematically illustrated in FIG. 3A. This may obviate the need for wire bond and/or interposer connections between the front side of the carrier board 60 and the front side of the ASIC 130, which may help to minimize the footprint of the radiation detector unit 210. In various embodiments, outer periphery of the carrier board 60 may not extend beyond the outer periphery of the ASIC(s) 130 and radiation sensor(s) 80 located over the carrier board 60 so as to provide a radiation detector unit 210 that is buttable on all four sides.

The TSVs 190 may be fabricated by forming plurality of deep openings in the substrate using photolithographic patterning and an anisotropic etching process, performing thin film deposition of insulating, barrier and/or metallic seed layers within each of the openings, and filling the openings with a metallic fill material via a suitable deposition process, such as an electrodeposition process. A thinning process, such as a grinding or chemical-mechanical planarization (CMP) process, may be used to remove material from the backside of the substrate to expose the TSVs 190. In some embodiments, the substrate may be thinned to a thickness of less than 200 μm, such as 10 to 150 μm, for example, 50 to 100 μm. The TSVs 190 may be formed using a “TSV first” process in which the plurality of TSVs 190 may be formed through a semiconductor material substrate (e.g., a silicon wafer) prior to fabricating the electronic circuit components (e.g., transistors, capacitors, resistors, etc.) of the ASIC 130 via front end of the line (FEOL) semiconductor fabrication processes. In other embodiments, the TSVs 190 may be formed after FEOL processes are complete but prior to the formation of metal interconnect structures via back end of the line (BEOL) fabrication processes. In still further embodiments, the TSVs 190 may be formed using a “TSV last” process either during or following the completion of BEOL processes. “TSV last” fabrication may provide the highest degree of flexibility, as the ASIC 130 may be initially fabricated at a silicon foundry and then subsequently processed to form the TSVs 190.

Each of the TSVs 190 may have dimensions along horizontal directions hd1 and hd2 that are between about 1 μm and about 200 μm, although greater and lesser dimensions for the TSVs 190 may also be utilized. In one non-limiting embodiment, the dimensions of the TSVs 190 along horizontal directions hd1 and hd2 may be about 50 μm. As noted above, each of the TSVs 190 is located in a pixel region 180 of the ASIC 130 that underlies a pixel detector 126 of the radiation sensor 80. Thus, each of the TSVs 190 shares the pixel region 180 in which it is located with a contact region 181 that electrically couples the pixel region 180 to the overlying pixel detector 126 of a radiation sensor 80 via a bonding material portion 82. The TSVs 190 may be laterally spaced from the contact regions 181 to avoid electrically-shorting the bonding material portions 82 to the TSV 190. Metal interconnect structures (not shown in FIGS. 3A and 3B) on the front side of the ASIC 130 may electrically couple the TSVs 190 to the various circuit components (e.g., transistors, resistors, capacitors, etc.) of the ASIC 130. In the embodiment shown in FIGS. 3A and 3B, each of the pixel regions 180 of the ASIC 130 includes a single TSV 190, although it will be understood that in other embodiments, some or all of the pixel regions 180 may include multiple TSVs 190, and/or some of the pixel regions 180 may not include any TSVs 190. The total number of TSVs 190 may be sufficient to provide all the required electronic signaling (e.g., control signals and data output signals) between the ASIC 130 and the carrier board 60 as well as to provide all the required power to the ASIC 130.

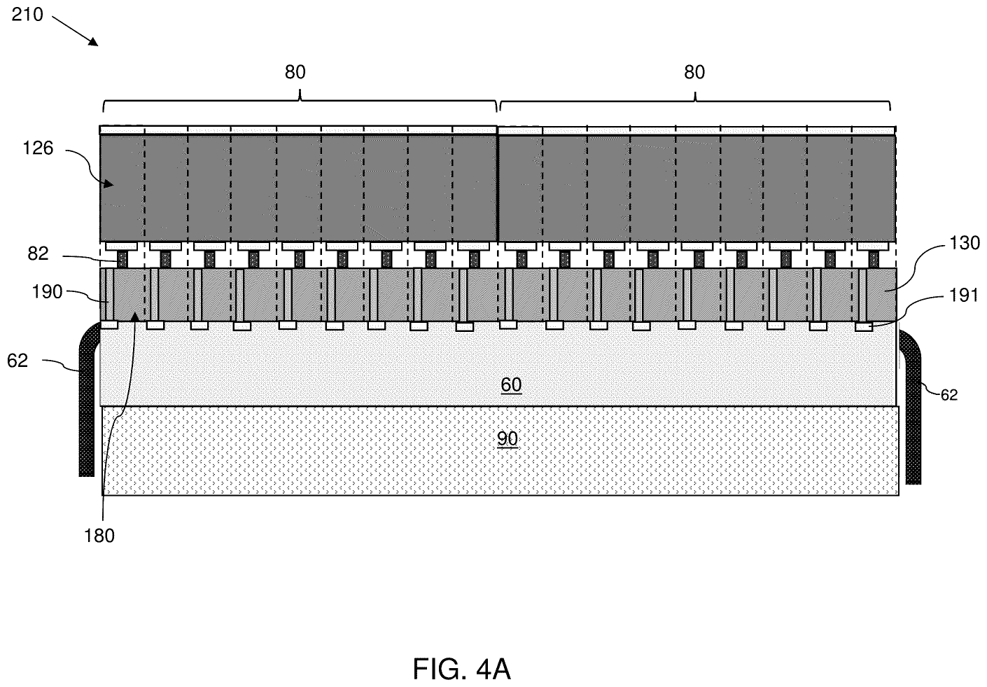

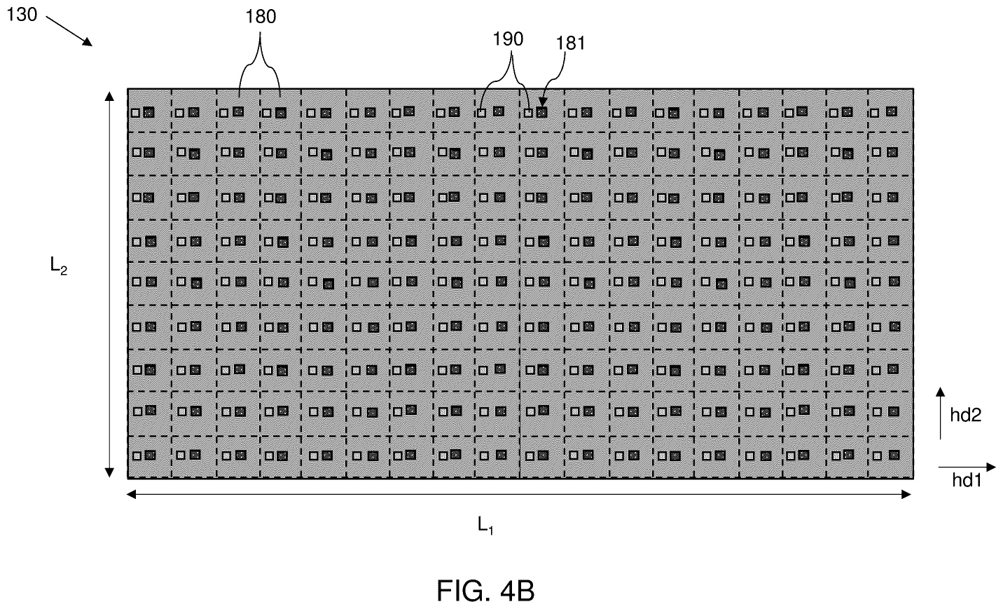

FIG. 4A is a vertical cross-section view of an alternative configuration of a radiation detector unit 210 according to an embodiment of the present disclosure. In this embodiment, a pair of radiation sensors 80 is directly mounted to An ASIC 130 via a plurality of bonding material portions 82. Thus, as shown in FIG. 4B, which is a plan view of the ASIC 130 of the radiation detector unit 210 of FIG. 4A, the ASIC 130 may include a length dimension L₁ along the first horizontal direction hd1 that is equal to the combined length dimensions of the pair of radiation sensors 80, and a width dimension L₂ along the second horizontal direction hd2 that is equal to the corresponding width dimensions of the radiation sensors 80. The ASIC 130 in this embodiment includes a contact region 181 and a TSV 190 within each of the pixel regions 180.

The radiation detector unit 210 of FIG. 4A includes a pair of cable connections 62 (e.g., flex cable assemblies) on opposite sides of the carrier board 60. In addition, the radiation sensors 80, the ASIC 130, and the carrier board 60 are mounted to a supporting substrate (e.g., a block) 90 as shown in FIG. 4A. The supporting substrate may include a high thermal conductivity material such as a metal (e.g., aluminum, copper, etc.). The supporting substrate 90 may function as a heat sink for the radiation detector unit 210. The supporting substrate 90 may be attached to the backside of the carrier board 60 using a thermally conductive adhesive such as a thermally conductive paste, and/or by mechanical connection structures (such as snap-in connectors, screws, and/or bolts and nuts).

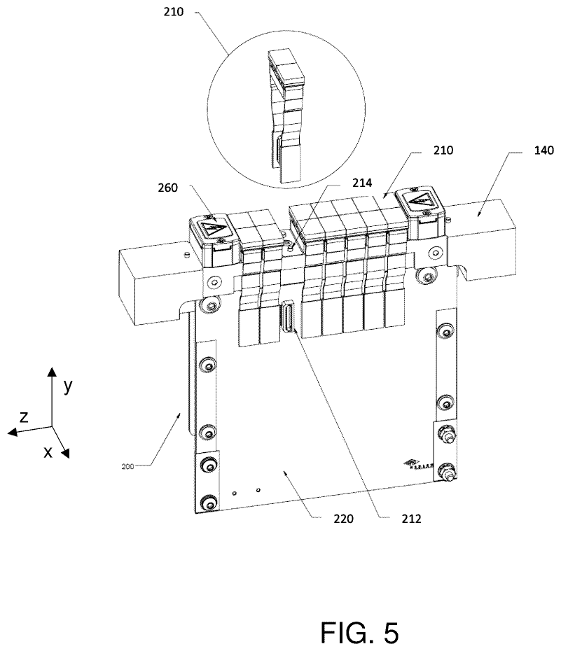

FIG. 5 is a perspective view of a detector module 200 including a plurality of radiation detector units 210 mounted to an above-described frame bar 140. Referring to FIG. 5, a row of radiation detector units 210 may be mounted to the front side of the frame bar 140. Engagement features 214 may optionally be provided on the front side of the frame bar 140 that may made with corresponding engagement features (not shown) on the backside of the supporting substrate 90 of each of the radiation detector units 210. End holders 260 may optionally be located at either end of the row of radiation detector units 210. A module circuit board 120 may be mechanically coupled to the frame bar 140 by suitable mechanical fastener(s). Each radiation detector unit 210 of the detector module may be electrically coupled to the module circuit board 220 by a flex cable assembly 62. In the embodiment shown in FIG. 5, the module circuit board 220 may include board-side connectors 212, where each board-side connector 212 may be connected to a connector, such as a snap-in connector 66, of a respective flex cable.

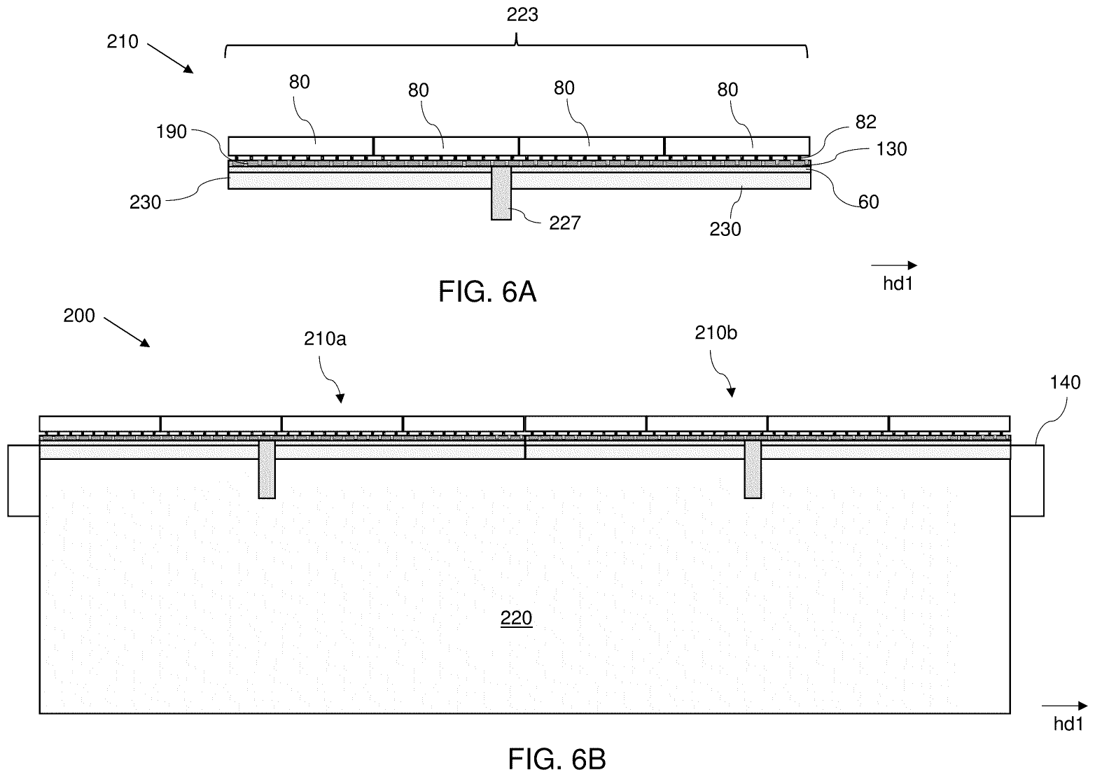

FIG. 6A is a vertical cross-section view of an alternative configuration of a radiation detector unit 210 according to an embodiment of the present disclosure. In the embodiment shown in FIG. 6A, a plurality of radiation sensors 80 are directly mounted to the front side of the ASIC 130 via bonding material portions 82. In the embodiment shown in FIG. 6A, the radiation detector unit 210 includes four radiation sensors 80 mounted over the front surface of the ASIC 130, although a greater or lesser numbers (e.g., between 1-8) of radiation sensors 80 may be mounted over the front surface of the ASIC 130. The radiation sensors 80 may abut one another along a first horizontal direction hd1 such that they provide a continuous radiation sensor area 223. The continuous radiation sensor area 223 may also extend across the entire width of the radiation detector unit 210 along a second horizontal direction that is perpendicular to the first horizontal direction hd1. The ASIC 130 may include a plurality of TSVs 190 located within pixel regions of the ASIC 130 underlying a pixel detector of a radiation sensor 80. The ASIC 130 may be located on a carrier board 60, which may be similar or identical to the carrier board 60 described above with reference to FIG. 3A. The carrier board 60 may be electrically coupled to the ASIC 130 via the plurality of TSVs 190. In some embodiments, an optional stiffening member 230 may be located on the backside of the carrier board 60 to provide increased mechanical support and stiffness to the radiation detector unit 210. At least one electrical connector 227 may be electrically connected to the radiation detector unit 210. In the embodiment shown in FIG. 6A, an electrical connector 227 is connected to the carrier board 60. The electrical connector 227 may be configured to route power supply to the ASIC 130, control signals to the ASIC 130, and data signals generated by the ASIC 130. In some embodiments, the electrical connector 227 may be a flex cable assembly as described above, although other suitable electrical connectors are within the contemplated scope of disclosure. Furthermore, although a single electrical connector 227 is shown in FIG. 6A, it will be understood that multiple electrical connectors 227 may be connected to the carrier board 60. For example, a high voltage electrical connector may be connected to the carrier board 60 and used to selectively provide a bias voltage to the radiation sensors 80 (e.g., to the cathodes of the radiation sensors) of the radiation detector unit 210.

FIG. 6B is a side elevation view of a detector module 200 including a plurality of radiation detector units 210a, 210b as described above with reference to FIG. 6A. Referring to FIG. 6B, a pair of above-described radiation detector units 210a, 210b may be arranged such that the peripheral edges 221 of the radiation detector units 210a, 210b abut against one another. This may increase the effective length of the continuous radiation sensor area 223 along the first horizontal direction hd1, which may correspond to the z-axis dimension in the assembled detector array as shown in FIG. 2. In various embodiments, the effective length of the continuous radiation sensor area 123 of the butted radiation detector units 210a, 210b may be at least about 6 cm, such as 8-40 cm, including between 12-24 cm (e.g., 14-18 cm). In some embodiments, the effective length of the continuous radiation sensor area 123 may be at least about 16 cm. A detector system including butted radiation detector units 210a, 210b and providing a continuous radiation sensor area 123 having an effective length in the z-axis direction of at least about 16 cm may be beneficial for a number of imaging applications, such as cardiac CT scanning. In the case of cardiac CT scans, for example, a larger detector length in the z-axis direction may enable the entire heart to be imaged in a single rotation about the patient (i.e., a single image slice).

The pair of detector modules 210a and 210b may be mounted over the front surface of a frame bar 140 that may function as a substrate for structurally holding the radiation detector units 210a and 210b in a butted configuration as shown in FIG. 6B. In some embodiments, the front surface of the frame bar 140 may include non-planar features, such as an outer lip or rim portion and a recessed flat central portion, to facilitate alignment of the radiation detector units 210a and 210b on the frame bar 140. In some embodiments, the frame bar 140 may be attached to the radiation detector units 210a and 210b using a thermally conductive adhesive, such as a thermally conductive paste, and/or by mechanical connection structures (such as snap-in connectors, screws, and/or bolts and nuts). The detector module 200 may further include a module circuit board 220 as described above with reference to FIG. 2. The detector module 200 may be attached to the frame bar 140 such that the module circuit board 220 may extend away from the rear side of the frame bar 140. Electrical connections between the respective radiation detector units 210a, 210b and the module circuit board 220 of the detector module 210 may be made via electrical connectors 227.

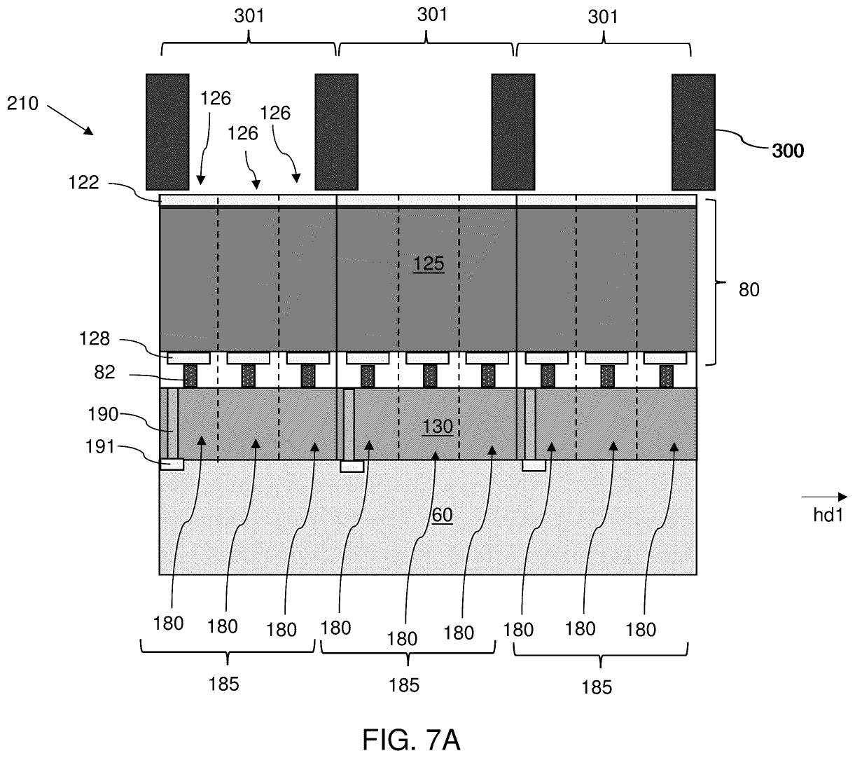

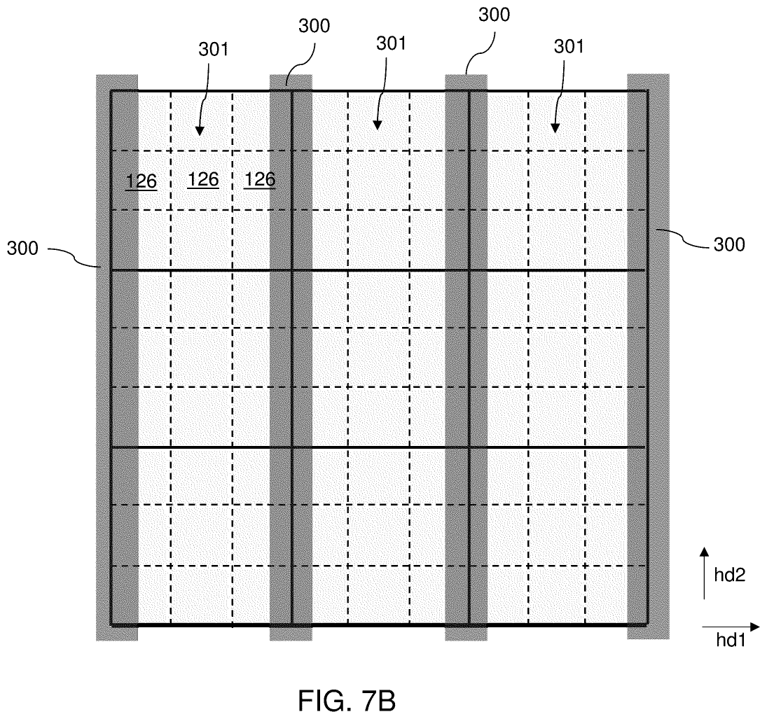

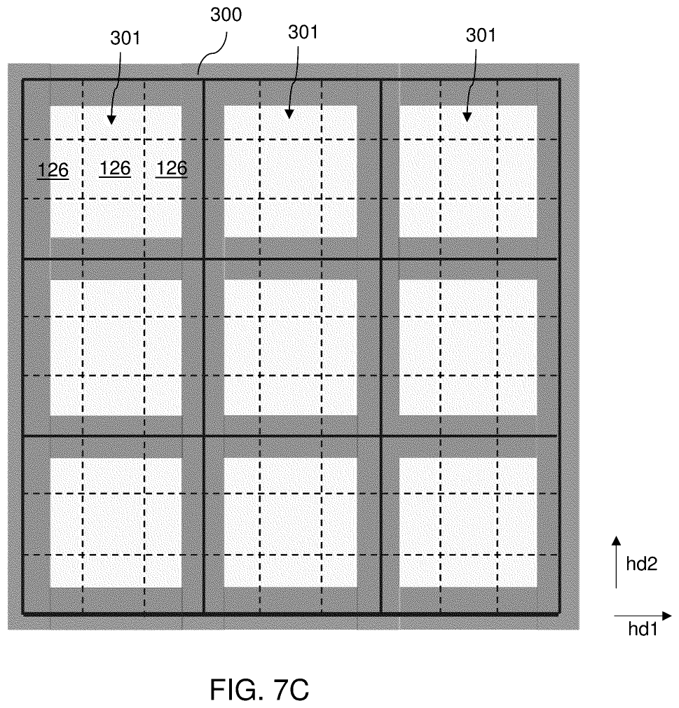

FIG. 7A is a vertical cross-section view of a radiation detector unit 210 including an anti-scatter grid (ASG) 300 disposed over the front side of the radiation sensor 80. The ASG 400 may be composed of a suitable X-ray absorbing material (e.g., lead) that is configured to reduce the number of scattered photons that reach the surface of the radiation sensor 80. The ASG 300 may include a network of vertically extending partitions (i.e., septa) aligned over the front surface of the radiation sensor 80 and including openings between the partitions. The ASG 300 may have a height dimension between 70 μm and 200 μm (e.g., ˜100 μm) although greater and lesser height dimensions may also be utilized. The ASG 300 may be a one-dimensional ASG, which includes a series of spaced-apart parallel partitions extending along a horizontal direction (i.e., in a direction perpendicular to hd1 in FIG. 7A), or a two-dimensional ASG in which the partitions extend in a grid-like manner along two orthogonal horizontal directions. FIG. 7B is a top view schematically illustrating a one-dimensional ASG 300, and FIG. 7C is a top view illustrating a two-dimensional ASG 300. The ASGs 300 in FIGS. 7B and 7C are partially-transparent to illustrate the position of the ASG 300 with respect to the array of pixel detectors 126 of the radiation sensor 80.

In some embodiments, sets of neighboring pixel detectors 126, such as contiguous N×M regions of pixel detectors 126, may form macro-pixels 301. In the embodiment of FIGS. 7A-7C, each of the macro-pixels 301 includes a 3×3 region of pixel detectors 126, although it will be understood that other sizes of the pixel regions forming the macro-pixels may be utilized. The size of the macro-pixels 301 may correspond to the geometry of the ASG 301 located over the radiation sensor 80. In the case of a one-dimensional ASG 301 as shown in FIG. 7B, for example, the ASG 301 may be aligned over two peripheral edges on either side of each macro-pixel 301. In the case of a two-dimensional ASG 301 as shown in FIG. 7C, the ASG 301 may be aligned over all four peripheral edges of the macro-pixels 301. (In FIGS. 7A-7C, the peripheral edges of each macro-pixel 301 are indicated by solid lines while the edges of the individual pixel detectors 126 within each macro-pixel 301 are indicated by dashed lines). In various embodiments, the ASIC 130 may be configured to read-out count data for each macro-pixel 301 of the radiation sensor 80. In the embodiment shown in FIG. 7A, the ASIC 130 may include a plurality of macro-pixel regions 185 underlying each of the macro-pixels 301 of the radiation sensor 80, as shown in FIG. 7A. Each of the macro-pixel regions 185 may include a set of N×M pixel regions 180 that corresponds to the set of N×M pixel detectors 126 that form the overlying macro-pixel 301. In some embodiments, each macro-pixel region 185 of the ASIC 130 may include at least one TSV 190 (e.g., for transmitting photon count data for the respective macro-pixels 301). FIG. 7A illustrates an embodiment in which each macro-pixel region 185 includes a single TSV 190. However, it will be understood that the macro-pixel regions 185 may include more than one TSV 190.

Referring to FIGS. 7A-7C, the ASG 300 may partially shield a subset of the pixel detectors 126 of the radiation sensor 80 such that the ASG 300 may block portions of the pixel detectors 126 underlying the ASG 300 from receiving photons. In the case of the one-dimensional ASG 300 as shown in FIG. 7B, the individual pixel detectors 126 along two peripheral edges of the macro-pixels 301 are partially shielded, whereas in the case of the two-dimensional ASG 300 shown in FIG. 7B, the individual pixel detectors 126 along all four peripheral edges of the macro-pixels 301 are partially shielded. Thus, in the case of a 3×3 macro-pixel 301 as shown in FIGS. 7A-7C, six of the nine individual pixel detectors 126 in each macro-pixel 301 are partially shielded by a one-dimensional ASG 300, and eight of the nine individual pixel detectors 126 in each macro-pixel 301 are partially shielded by a two-dimensional ASG 300. In various embodiments of the present disclosure, none of the individual pixel detectors 126 are fully shielded by the ASG 300, such that each individual pixel detector 126 is an active pixel detector that receives and detects photons impinging on the unshielded portion of the pixel detector 126 that may be read-out as photon count data by the ASIC 130. Thus, there are no inactive (i.e., dummy) pixel detectors 126 which are fully shielded by the ASG 300 and is not used to detect photons.

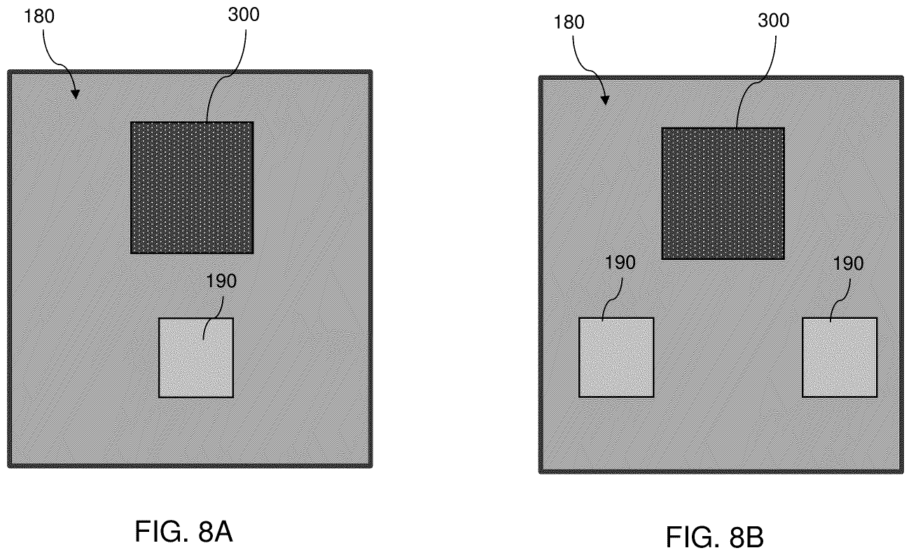

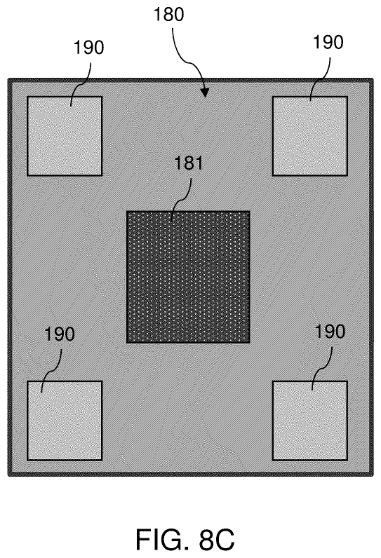

FIG. 8A is a top view of a pixel region 180 of An ASIC 130 illustrating a layout of a contact region 181 and a TSV 190 according to an embodiment of the present disclosure. As discussed above, each of the pixel regions 180 of the ASIC 130 includes a contact region 181 that contacts a bonding material portion 82 that electrically connects the pixel region 180 to the overlying pixel detector 126 of a radiation sensor 80. As additionally discussed above, at least some of the pixel regions 180 of the ASIC 130 may also include one or more TSVs 190 that extend through the ASIC 130 and electrically connect the ASIC 130 to an underlying carrier board 60. The TSVs 190 may transmit power to the ASIC 130 and/or may transmit digital signals (e.g., control signals, data signals) between the ASIC 130 and the carrier board 60. FIG. 8A illustrates an example layout of a pixel region 180 including a contact region 181 and a single TSV 190. In some embodiments, in order to accommodate TSV 190 as well as the various circuit components (e.g., analog and/or digital readout circuit components) located within the pixel region 180, the contact region 181 may have an offset configuration such that the centroid of the contact region 181 does not correspond to the centroid of the pixel region 180. In other words, the contact region 181 may be shifted from the center of the pixel region 180 towards a peripheral edge of the pixel region 180. In some embodiments, the back side (i.e., anode-side) of the overlying radiation detector 80 may include one or more dielectric material layers, such as a passivation layer composed of a suitable dielectric material (e.g., SiO₂, SiN, etc.) and/or a solder resist layer (i.e., soldermask) to prevent electrical shorting between adjacent pixel detectors 126.

FIG. 8B illustrates an alternative layout of a pixel region 180 of An ASIC 130 including a contact region 181 and a pair of TSVs 190. The contact region 181 may be offset towards one side of the pixel region 180 and the pair of TSVs 190 may be located on the opposite side of the pixel region 180 and laterally-spaced from one another. The TSVs 190 may be of the same type (i.e., may both be used to transmit power or may both be used to transmit control and/or data signals) or may be of different types (i.e., one TSV 190 may be used to transmit power and the other TSV 190 may be used to transmit control and/or data signals). In some embodiments, described in further detail below, the multiple TSVs 190 may include redundant TSVs 190, such that both of the TSVs 190 within the pixel region 180 may be connected in parallel to a common node on the carrier board 60. For example, both of the TSVs 190 may be connected in parallel to a common power supply node (e.g., a positive supply voltage (Vdd) node or a ground voltage (Vdd) node) of the carrier board 60. Alternatively, both of the TSVs 190 may be connected in parallel to a common data transfer node (e.g., a positive or negative LVDS terminal, a control signal channel, etc.) of the carrier board 60.

FIG. 8C illustrates another alternative layout of a pixel region 180 of An ASIC 130 including a contact region 181 and four TSVs 190. The contact region 181 in this embodiment is located in the center of the pixel region 180. As in the embodiment of FIG. 8B, the TSVs 190 may be of the same type or may be of different types. In some embodiments, multiple TSVs 190, including all four TSVs 190 within the pixel region 180, may be electrically connected in parallel to provide redundant TSVs 190. Various other layout configurations for a pixel region 180 including a contact region 181 and one or more TSVs 190 are within the contemplated scope of disclosure.

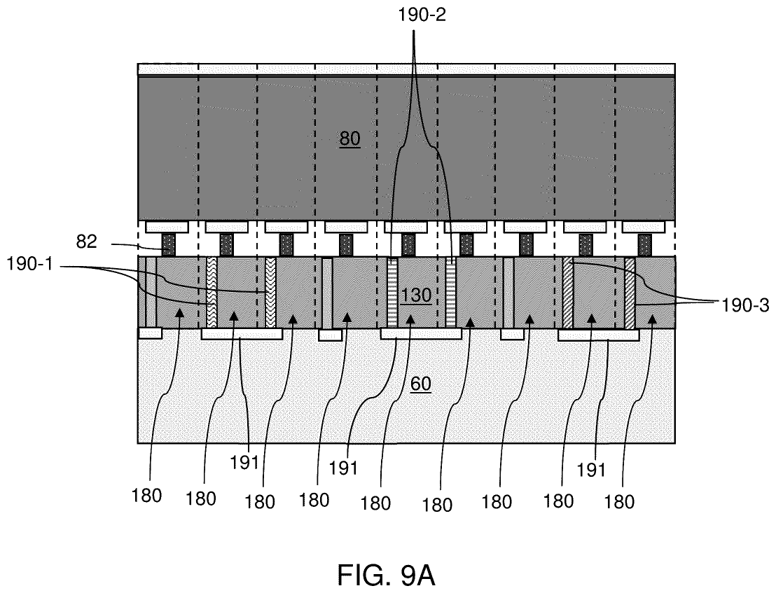

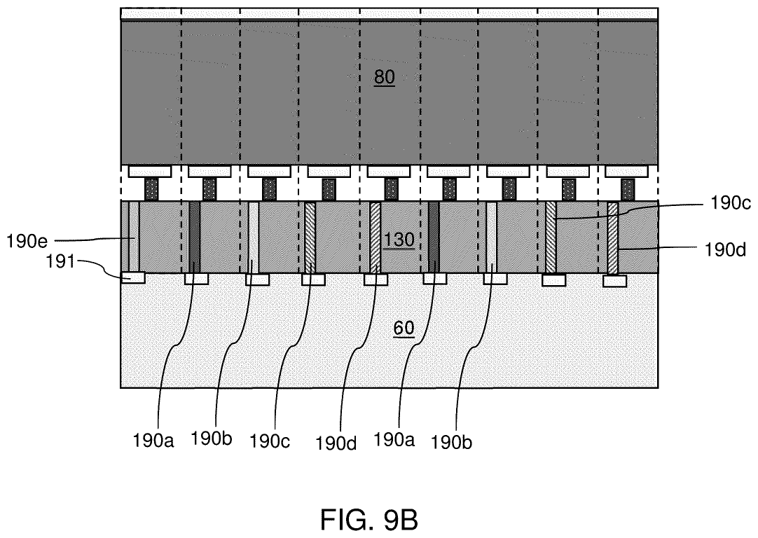

FIG. 9A is a vertical cross-section view of a radiation detector unit 210 including redundant TSVs 190 extending through the ASIC 130. Referring to FIG. 9A, multiple sets of TSVs 190-1, 190-2 and 190-3 may be connected in parallel, such as via a conductive trace 191 on the carrier board 60, to provide redundant TSVs 190. In the embodiment of FIG. 9A, pairs of TSVs 190-1, 190-2 and 190-3 are connected in parallel by conductive traces 191 on the carrier board 60 that extend continuously between the respective pairs of TSVs 190-1, 190-2 and 190-3. In other embodiments, more than two TSVs 190 may be connected in parallel to provide redundant TSVs. Sets of redundant TSVs 190 may be located within a single pixel region 180 and/or macro-pixel region 185, or may extend over multiple pixel regions 180 and/or macro-pixel regions 185 of the ASIC 130. Each set of redundant TSVs 190-1, 190-2 and 190-3 may carry the same type of signal, such as a power signal (e.g., a positive supply voltage (Vdd) or a ground voltage (Vss)) or a data signal (e.g., LVDS signals having a first polarity, LVDS signals having a second polarity, control signals, etc.). Providing redundant TSVs 190 may protect against failures (e.g., faulty connections, etc.) in some of the TSVs 190 of the ASIC 130. In particular, redundant TSVs 190 may be used to carry output data signals (e.g., LVDS signals) from each pixel region 180 and/or macro-pixel region 185 of the ASIC 130 to ensure that no photon count data is lost. Additional redundant TSVs 190 may be provided to ensure there is no interruption in control signals between the carrier board 60 and the ASIC 130.

FIG. 9B is a vertical cross-section view of a radiation detector unit 210 illustrating an arrangement of TSVs 190 carrying different types of signals. A first subset of TSVs 190a may carry a first type of power signal, such as a positive supply voltage (Vdd). A second subset of TSVs 190b may carry a second type of power signal, such as a negative or ground voltage (Vss). In some embodiments, all or a portion of the TSVs 190a and 190b within each subset may be connected in parallel to provide redundant TSVs 190a and 190b providing the power supply to the ASIC 130. The TSVs 190a and 190b carrying the different power signals may be interleaved with one another (i.e., TSVs 190a and 190b may be adjacent and alternating with one another) to benefit from their mutual capacitance.

Referring again to FIG. 9B, a third subset of TSVs 190c may carry a first type of data signal (e.g., LVDS signals having a first polarity) and a fourth subset of TSVs 190d may carry a second type of data signal (e.g., LVDS signals having a second polarity). While embodiments with LVDS input/output protocol are described herein, it should be understood that other input/output protocols may also be used. In some embodiments, each pixel region 180 and/or each macro-pixel region 185 of the ASIC 130 may include at least one instance of the third subset of TSVs 190c and at least one instance of the fourth subset of TSVs 190d. Thus, each pixel region 180 or macro-pixel region 185 may transmit count data for the respective pixel detector 126 or macro-pixel 301 overlying the pixel region 180 or macro-pixel region 185 to the underlying carrier board 60. The TSVs 190c and 190d in each pixel region 180 and/or in each macro-pixel region 185 may have a redundant configuration as described above to ensure continuity of image data transmission from each pixel detector 126 and/or macro-pixel 301. The TSVs 190c and 190d carrying the different data signals may be interleaved with one another (i.e., TSVs 190c and 190d may be adjacent and alternating with one another) to reduce AC coupled noise to neighboring signals. As shown in FIG. 9B, TSVs 190a and 190b carrying power signals may be interleaved with the TSVs 190c and 190d carrying data signals for the respective pixel region 180 or macro-pixel region 185. In other words, sets of TSVs 190a and 190b carrying power signals may be located between sets of TSVs 190c and 190d transmitting data signals from neighboring pixel regions 180 or macro-pixel regions 185.

In some embodiments, a fifth subset of TSVs 190e may be used to transmit additional data signals, such as control signals that may be exchanged between the carrier board 60 and the ASIC 130. The fifth subset of TSVs 190e may also include a redundant configuration as described above.

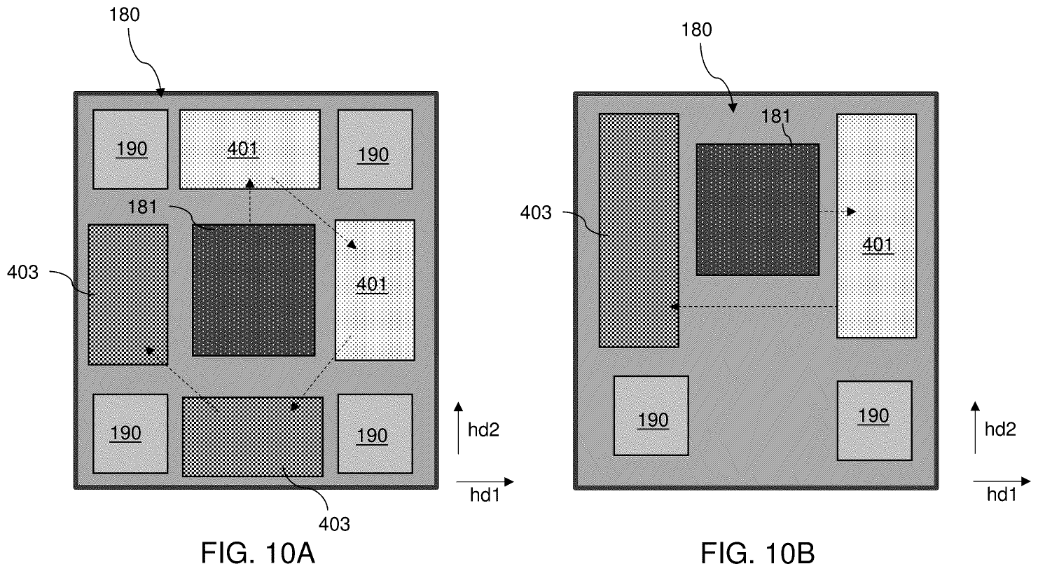

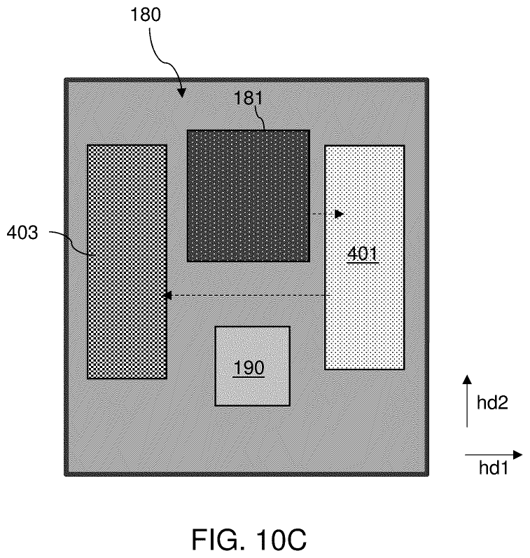

FIG. 10A is a top view of a pixel region 180 of An ASIC 130 illustrating a layout of read-out circuitry according to an embodiment of the present disclosure. Each pixel region 180 of the ASIC 130 may include read-out circuitry that includes a combination of analog and digital circuits. The analog circuits may include, for example, one or more charge circuit amplifiers (CSA), CBF reset circuits, base line restoration (BLR) circuits, and shapers. The digital circuits may include, for example, one or more comparators, counters, control registers, and serial peripheral interface (SPI) input/output circuits. The analog circuits and the digital circuits may each be grouped together in one or more circuit blocks to provide isolation between the analog and digital circuits. This may help to minimize switching in the digital circuits inducing unwanted noise in the analog circuits. In some embodiments, layout of the pixel region 180 may utilize the contact region 181 and one or more TSVs 190 to promote isolation between analog and digital circuit blocks in the pixel region 180.

FIG. 10A illustrates a pixel region 180 that includes a contact region 181 located in the center of the pixel region 180 and four TSVs 190 located near the respective corners of the pixel region 180. Analog circuit blocks 401 may be located along two adjacent sides of the contact region 181 and digital circuit blocks 403 may be located along the other two adjacent sides of the contact region 181. Each of the analog and digital circuit blocks 401 and 403 may be located between a pair of TSVs 190. Thus, the analog circuit blocks 401 may be separated from the digital circuit blocks 403 by the contact region 181 and/or a TSV 190, which may help to isolate the analog and digital circuits. The dashed arrows in FIG. 10A illustrate signal flow within the pixel region 180 of the ASIC 130. Analog detection signals may be received from the overlying pixel detector 126 via the bonding material portion 82 at the contact region 181. The detection signals may be initially processed at the analog circuit blocks 401 and then processed at the digital circuit blocks 403. The resulting digital detection signals (i.e., photon count data) may then be transmitted to the carrier board 60 via one or more TSVs 190.

FIG. 10B illustrates an alternative layout for a pixel region 180 that includes a contact region 181 and a pair of TSVs 190. The contact region 181 is offset towards one side of the pixel region 180 and the pair of TSVs 190 are located on the opposite side of the pixel region 180 and laterally-spaced from one another along a first horizontal direction hd1. An analog circuit block 401 is located on one side of the contact region 181 and a digital circuit block 403 is located on the opposite side of the contact region 181. The dashed arrows indicate the signal flow within the pixel region 180.

FIG. 10C illustrates another alternative layout for a pixel region 180 that includes a contact region 181 and one TSV 190. The contact region 181 is offset towards one side of the pixel region 180 and the TSV 190 is located on the opposite side of the pixel region 180. An analog circuit block 401 extends along one side of the contact region 181 and the TSV 190 and a digital circuit block 403 extends along the opposite side of the contact region 181 and the TSV 190. The dashed arrows indicate the signal flow within the pixel region 180.

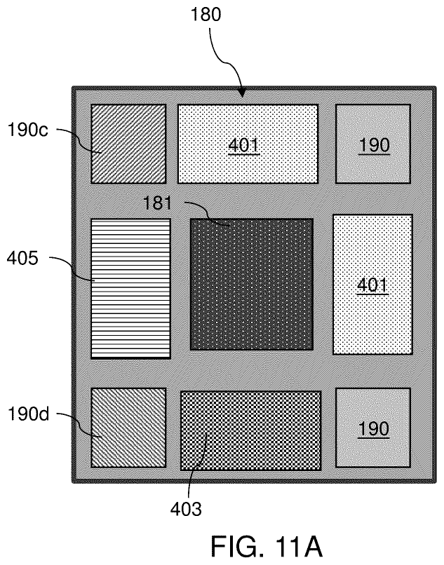

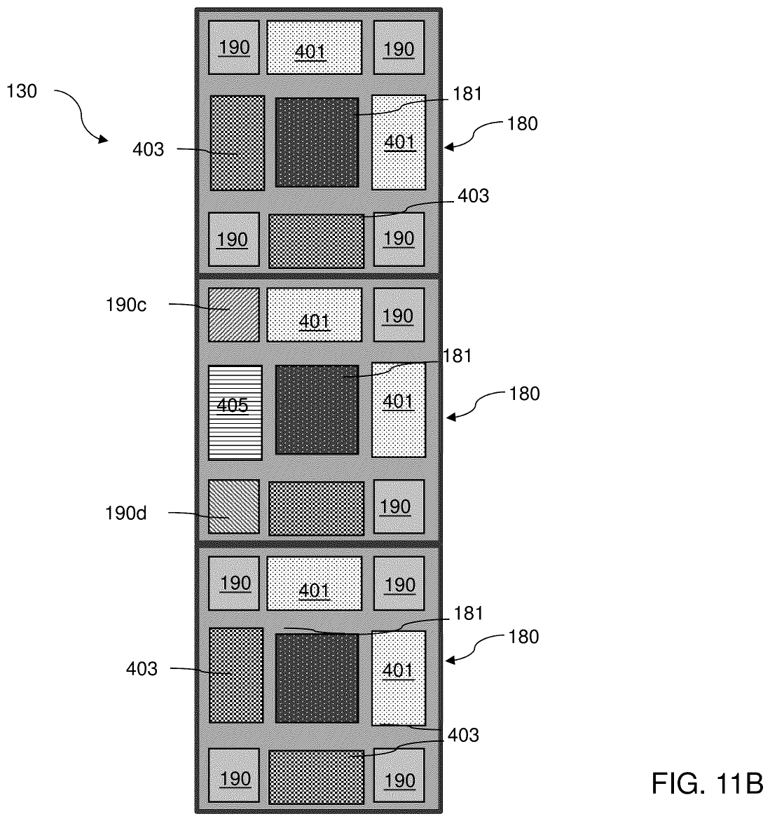

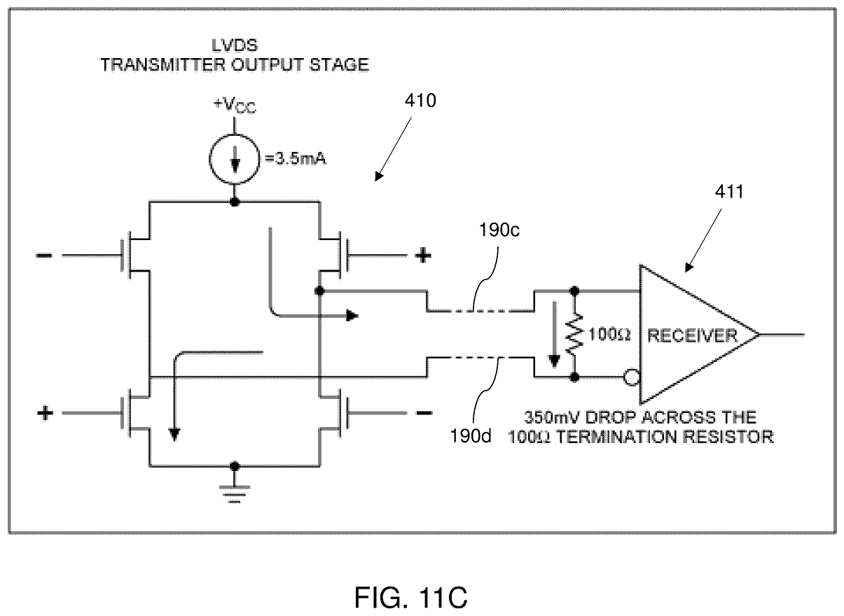

FIG. 11A is a top view of a pixel region 180 of An ASIC 130 illustrating a layout of read-out circuitry including low voltage differential signaling (LVDS) circuitry according to an embodiment of the present disclosure. LVDS is a standard high-speed input/output transmission protocol that may be used to transmit photon count data from the ASIC 130 to the carrier board 60. Data transmission via LVDS requires LVDS transmitter circuitry, which may include driver circuitry, data aggregation circuitry to temporarily store the transmitted image data, and in some cases clock circuitry. In some embodiments, a subset of the pixel regions 180 of the ASIC 130 may include LVDS circuitry, which may be grouped together in an LVDS circuit block 405. In some embodiments, each of the pixel regions 180 that include an LVDS circuit block 405 may also include a pair of TSVs 190 that are configured to transmit the data from the ASIC 130 via differential signaling. The LVDS circuit block 405 may substitute for a digital circuit block 403 as described above. FIG. 11A illustrates an example layout of a pixel region 180 that includes an LVDS circuit block 405. The pixel region 180 includes a contact region 181 located in the center of the pixel region 180 and four TSVs 190 located near the respective corners of the pixel region 180. Analog circuit blocks 401 may be located along two adjacent sides of the contact region 181. A single digital circuit block 403 and the LVDS circuit block 405 may be located along the other two adjacent sides of the contact region 181. Each of the analog and digital circuit blocks 401 and 403 and the LVDS circuit block 405 may be located between a pair of TSVs 190. The LVDS circuit block 405 may be located between a pair of TSVs 190c and 190d that may each be used to transmit LVDS signals having opposite polarities such that the digital output data stream may be transmitted to the carrier board 60 via differential signaling. In some embodiments, each of the pixel regions 180 including an LVDS circuit block 405 may be located along a peripheral edge of the ASIC 130 and may be used to transmit photon count signals from a plurality of pixel regions 180 and/or macro-pixel regions 185.

FIG. 11B is a top view of a portion of An ASIC 130 including three pixel regions 180. Each of the pixel regions 180 includes a contact region 181 located in the center of the pixel region 180, four TSVs 190 located near the respective corners of the pixel region 180, and analog circuit blocks 401 located along two adjacent sides of the contact region 181. Two of the pixel regions 180 located at the top and bottom of FIG. 11B include a pair of digital circuit blocks 403 located along the other two adjacent sides of the contact region 181. The middle pixel region 180 includes a single digital circuit block 403 and the LVDS circuit block 405 located along the other two adjacent sides of the contact region 181. In some embodiments, the digital circuit blocks 403 from the pixel regions 180 above and/or below the pixel region 180 containing the LVDS circuit block 405 may be used as needed to for digital processing of data from the middle pixel region 180 that only includes a single digital circuit block 403. In some embodiments, a distributed LVDS transmission scheme may be utilized in which LVDS transmission of the digital output data stream may be shared by LVDS circuit blocks 405 located in different regions of the ASIC 130. For example, every third or fourth pixel region 180 along the peripheral edges of the ASIC 130 may include an LVDS circuit block 405 as shown in FIG. 11B. This may help to provide a more uniform heat distribution across the ASIC 130. In addition, the circuitry required for LVDS data transmission is typically relatively large, so a distributed LVDS transmission scheme may allow for more efficient use of space on the ASIC 130 by distributing the LVDS circuitry between multiple pixel regions 180.

FIG. 11C is a circuit diagram schematically illustrating a transmitter 410 and receiver 411 that may be used for transmitting data from An ASIC 130 to a carrier board 60 using LVDS according to an embodiment of the present disclosure. The transmitter 410 may be located in a pixel region 180 of the ASIC 130 and the receiver 411 may be located on the carrier board 60. Signals having opposite polarity may be transmitted from the transmitter 410 to the receiver 411 via TSVs 190c and 190d as indicated in FIG. 11C. The receiver 411 may measure the voltage difference across a resistor, which may determine the logic state of the digital output signals.

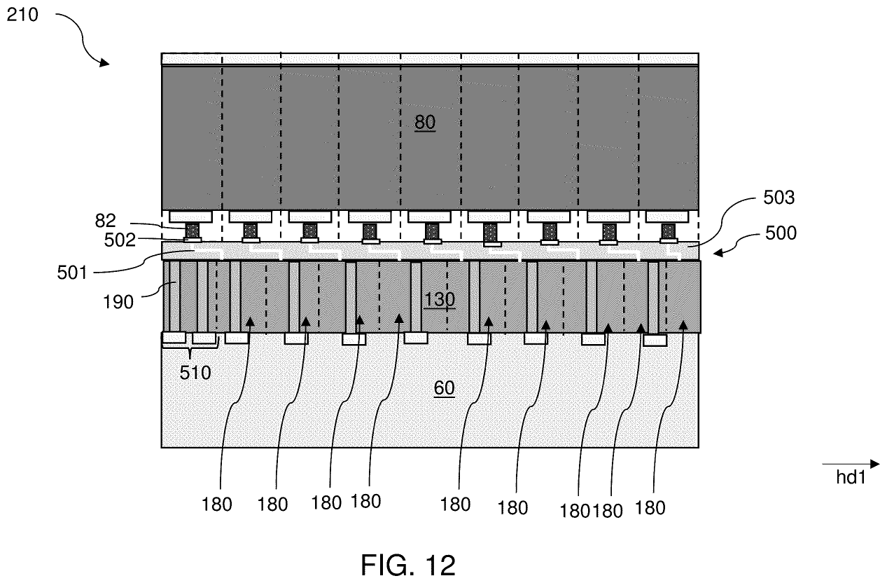

FIG. 12 is a vertical cross-section view of a radiation detector unit 210 that includes a redistribution layer 500 over the front surface of the ASIC 130 according to an embodiment of the present disclosure. The redistribution layer 500 may include a plurality of contact regions 502 that are electrically connected to respective anode electrodes 128 of the pixel detectors 126 of the radiation sensor 80. The redistribution layer 500 may further include metal interconnect structures 501 embedded in a dielectric material matrix 503 that electrically couple each of the contact regions 502 to a pixel region 180 of the ASIC 80. In various embodiments, the redistribution layer 500 may enable the pixel regions 180 of the ASIC 80 to be laterally shifted with respect to the pixel detectors 126 to which each of the pixel regions 180 is electrically coupled. Thus, the peripheral edges of the pixel regions 180 may not be aligned with the peripheral edges of the corresponding pixel detectors 126 but may be laterally offset from the peripheral edges of the corresponding pixel detectors 126 as shown in FIG. 12. The laterally-shifted pixel regions 180 may include above-described analog circuit blocks 401 and digital circuit blocks 403 for processing of detector signals received from the pixel detectors 126 via the redistribution layer 500. The laterally-shifted pixel regions 180 may also include TSVs 190. The lateral shift of the pixel regions 180 may provide an excess space 510 on the ASIC 130 underlying the radiation sensor 80 as shown in FIG. 12. The excess space 510 may include common circuitry for the ASIC 130 (i.e., circuitry that provides functionality for multiple pixel regions 180 and/or macro-pixel regions 185 of the ASIC 130). Examples of common circuitry that may be located in the excess space 510 includes, without limitation, above-described LVDS circuit blocks 405, voltage reference circuitry, and/or control circuitry for the ASIC 130. The excess space 510 may further include one or more TSVs 190, as shown in FIG. 12. The TSVs 190 may be used to carry power signals and/or data signals (e.g., control signals and/or data output signals). In some embodiments, the excess space 510 may be located along a peripheral edge of the ASIC 130. While embodiments with LVDS input/output circuits are described herein, it should be understood that other input/output circuits may also be used.

The devices of the embodiments of the present disclosure can be employed in various radiation detection systems including computed tomography (CT) imaging systems. Any direct conversion radiation sensors may be employed such as radiation sensors employing Si, Ge, GaAs, CdTe, CdZnTe, and/or other similar semiconductor materials.

The radiation detectors of the present embodiments may be used for medical imaging, such as in Low-Flux applications in Nuclear Medicine (NM), whether by Single Photon Emission Computed Tomography (SPECT) or by Positron Emission Tomography (PET), or as radiation detectors in High-Flux applications as in X-ray Computed Tomography (CT) for medical applications, and for non-medical imaging applications, such as in baggage security scanning and industrial inspection applications.

While the disclosure has been described in terms of specific embodiments, it is evident in view of the foregoing description that numerous alternatives, modifications and variations will be apparent to those skilled in the art. Each of the embodiments described herein can be implemented individually or in combination with any other embodiment unless expressly stated otherwise or clearly incompatible. Accordingly, the disclosure is intended to encompass all such alternatives, modifications and variations which fall within the scope and spirit of the disclosure and the following claims.

1. A radiation detector unit, comprising:
at least one radiation sensor comprising a continuous array of active pixel detectors that generate event detection signals in response to photon interaction events occurring within the active pixel elements;
an application specific integrated circuit comprising circuit components on a substrate, wherein the at least one radiation sensor is mounted over a front surface of the application specific integrated circuit via a plurality of bonding material portions such that event detection signals generated in each of the active pixel detectors of the at least one radiation sensor are received at a respective pixel region of the application specific integrated circuit, and the circuit components of the application specific integrated circuit are configured convert the event detection signals received at each of the pixel regions of the application specific integrated circuit to digital detection signals; and
a carrier board underlying the application specific integrated circuit,
wherein the application specific integrated circuit comprises a plurality of through-substrate vias extending through the application specific integrated circuit and electrically coupling the application specific integrated circuit to the carrier board, and each of the through-substrate vias of the application specific integrated circuit underlies an active pixel detector of the at least one radiation sensor.

2. The radiation detector unit of claim 1, further comprising an anti-scatter grid located over a front surface of the radiation sensor and partially shielding a subset of the continuous array of active detector pixels.

3. The radiation detector unit of claim 2, wherein:
the at least one radiation sensor lacks any inactive detector pixels located under the anti-scatter grid; and
sets of neighboring active detector pixels of the continuous array of active detector pixels form a plurality of macro-pixels, and the anti-scatter grid partially shields active detector pixels along at least two peripheral edges of each macro-pixel.

4. The radiation detector unit of claim 3, wherein sets of pixel regions of the application specific integrated circuit that are electrically connected to active detector pixels of a macro-pixel form macro-pixel regions of the application specific integrated circuit, and each macro-pixel region of the application specific integrated circuit includes at least one through-substrate via.

5. The radiation detector unit of claim 1, wherein each pixel region of the application specific integrated circuit includes at least one through-substrate via.

6. The radiation detector unit of claim 1, wherein at least some of the pixel regions of the application specific integrated circuit include multiple through-substrate vias.

7. The radiation detector unit of claim 1, wherein dimensions of the application specific integrated circuit along orthogonal horizontal directions are substantially equal to the corresponding dimensions of the at least one radiation sensor along the corresponding orthogonal horizontal directions.

8. The radiation detector unit of claim 1, wherein each of the pixel regions of the application specific integrated circuit includes a contact region that contacts a bonding material portion.

9. The radiation detector unit of claim 8, wherein at least a portion of the pixel regions of the application specific integrated circuit include a through-substrate via that is laterally offset from the contact region.

10. The radiation detector unit of claim 9, wherein in pixel regions of the application specific integrated circuit that include a through-substrate via, the contact region has an offset configuration such that a centroid of the contact region does not correspond to the centroid of the pixel region.

11. The radiation detector unit of claim 10, wherein in pixel regions of the application specific integrated circuit that include a through-substrate via, the through substrate-via is laterally spaced from the contact region and the pixel region further comprises an analog circuit block extending on a first side of the contact region and the through-substrate via and a digital circuit block extending on a second side of the contact region and the through-substrate via.

12. The radiation detector unit of claim 9, wherein in pixel regions of the application specific integrated circuit that include a pair of through-substrate vias, the contact region is offset towards one side of the pixel region and the pair of through-substrate vias are laterally spaced from one another along a first horizontal direction and located on an opposite side of the pixel region from the contact region along a second horizontal direction.

13. The radiation detector unit of claim 12, wherein in pixel regions of the application specific integrated circuit that include a pair of through-substrate vias, the pixel regions further comprise an analog circuit block that is located on a first side of the contact region and a digital circuit block that is located on a second side of the contact region.

14. The radiation detector unit of claim 9, wherein at least a portion of the pixel regions of the application specific integrated circuit comprise a contact region and four through-substrate vias, the contact region located in a central portion of the pixel region and each of the four through-substrate vias located proximate to a respective corner of the pixel region.

15. The radiation detector unit of claim 14, wherein in the pixel regions of the application specific integrated circuit comprising a contact region and four through-substrate vias, a pair of analog circuit blocks are located along first and second adjacent sides of the contact region and at least one digital circuit block is located along a third side of the contact region, wherein each of the analog circuit blocks and the at least one digital circuit block are located between a pair of through-substrate vias.

16. The radiation detector unit of claim 15, wherein at least some of pixel regions of the application specific integrated circuit comprising a contact region and four through-substrate vias comprise a digital circuit block located along a fourth side of the contact region, wherein each of the digital circuit blocks is located between a pair of through-substrate vias.

17. The radiation detector unit of claim 15, wherein at least some of pixel regions of the application specific integrated circuit comprising a contact region and four through-substrate vias comprise a digital circuit block along a third side of the contact region and a low voltage differential signaling (LVDS) circuit block along a fourth side of the contact region and between a pair of through-substrate vias.

18. The radiation detector unit of claim 1, wherein the carrier board comprises a plurality of conductive traces on a front side of the carrier board that are electrically connected to each of the through-substrate vias of the application specific integrated circuit.

19. The radiation detector unit of claim 18, wherein at least some of the conductive traces on the front side of the carrier board extend continuously between multiple through-substrate vias to provide a plurality of redundant through-substrate vias.

20. The radiation detector unit of claim 19, wherein the redundant through-substrate vias carry power signals or a data signals.

21. The radiation detector unit of claim 20, wherein the data signals comprise at least one of control signals between the carrier board and the application specific integrated circuit and the digital detection signals.

22. The radiation detector unit of claim 21, wherein the digital detection signals are transmitted via a low voltage differential signal (LVDS) protocol such that a first set of redundant through-substrate vias carry first LVDS signals having a first polarity and a second set of redundant through-substrate vias carry second LVDS signals having a second polarity.

23. The radiation detector unit of claim 22, wherein the first set of redundant through-substrate vias carrying the first LVDS signals and the second set of redundant through-substrate vias carrying the second LVDS signals are interleaved to provide reduced AC coupled noise.

24. The radiation detector unit of claim 20, wherein the power signals include a positive voltage power supply signal provided through a first set of redundant through-substrate vias and a negative voltage or ground power supply signal provided through a second set of redundant through-substrate vias.

25. The radiation detector unit of claim 24, wherein the first set of redundant through-substrate vias carrying the positive power supply signal and the second set of redundant through-substrate vias carrying the negative or ground power supply signals are interleaved to provide mutual capacitance.

26. The radiation detector unit of claim 1, wherein the outer periphery of each pixel detector of the at least one radiation sensor is vertically aligned with the outer periphery of each pixel region of the application specific integrated circuit.

27. The radiation detector unit of claim 1, further comprising a redistribution layer located over the front side of the application specific integrated circuit and comprising a plurality of conductive interconnect structures embedded in a dielectric material matrix and that electrically connect each of the bonding material portions to a respective pixel region of the application specific integrated circuit, wherein the outer periphery of each of the pixel regions of the application specific integrated circuit is laterally shifted with respect to the outer periphery of the pixel detector to which the pixel region is electrically connected.

28. The radiation detector of claim 27, further comprising an excess space on the application specific integrated circuit that does not comprise a pixel region, wherein the excess space comprises at least one through-substrate via and at least one of an LVDS circuit block, a voltage reference circuit, and a control circuit for the application specific integrated circuit.

29. A radiation detector unit, comprising:
at least one radiation sensor comprising a plurality of pixel detectors configured to generate event detection signals in response to photon interaction events occurring within the pixel elements;
an application specific integrated circuit underlying and electrically coupled to the at least one radiation sensor and configured convert the event detection signals to digital detection signals; and
a carrier board underlying the application specific integrated circuit,
wherein the application specific integrated circuit comprises a plurality of through-substrate vias extending through the application specific integrated circuit and electrically coupling the application specific integrated circuit to the carrier board, and the carrier board comprises a plurality of conductive traces extending continuously between sets of through-substrate vias to provide redundant electrical connections between the carrier board and the application specific integrated circuit.

30. The radiation detector unit of claim 29, wherein at least a portion of the redundant electrical connections between the carrier board and the application specific integrated circuit are used to transmit data signals.

31. The radiation detector unit of claim 30, wherein the data signals comprise control signals.

32. The radiation detector unit of claim 30, wherein the data signals comprise the digital detection signals.

33. The radiation detector unit of claim 32, wherein the digital detection signals are transmitted via a low voltage differential signaling protocol over redundant through-substrate vias.

34. A radiation detector unit, comprising:
at least one radiation sensor comprising a plurality of pixel detectors configured to generate event detection signals in response to photon interaction events occurring within the pixel elements;
an application specific integrated circuit underlying and electrically coupled to the at least one radiation sensor and configured convert the event detection signals to digital detection signals; and
a carrier board underlying the application specific integrated circuit,
wherein the application specific integrated circuit comprises a plurality of through-substrate vias extending through the application specific integrated circuit and electrically coupling the application specific integrated circuit to the carrier board; and
wherein the application specific integrated circuit comprises a plurality of low voltage differential signaling (LDVS) circuit blocks underlying the at least one radiation sensor and distributed over the application specific integrated circuit, and that are configured to transmit the digital detection signals from the application specific integrated circuit to the carrier board via the through-substrate vias.

35. The radiation detector unit of claim 34, wherein each of the LDVS circuit blocks of the plurality of LVDS circuit blocks is located adjacent to a peripheral edge of the application specific integrated circuit.

36. The radiation detector unit of claim 34, wherein the application specific integrated circuit comprises a plurality of pixel regions, each pixel region electrically-coupled to a respective pixel detector of the radiation sensor, and each of the LVDS circuit blocks is located in a pixel region of the application specific integrated circuit.

37. The radiation detector unit of claim 36, wherein each of the pixel regions containing an LVDS circuit block is separated from another pixel region containing an LVDS circuit block by at least one pixel region that does not contain an LVDS circuit block.

38. An X-ray imaging system, comprising:
a radiation source configured to emit an X-ray beam; and
a detector array including a plurality of radiation detector units of claim 1 that form a continuous detector surface and are configured to receive the X-ray beam from the radiation source through an intervening space configured to contain an object therein.

39. The X-ray imaging system of claim 38, wherein the X-ray imaging system comprises a photon-counting computerized tomography (PCCT) imaging system comprising an image reconstruction system including a computer configured to run an automated image reconstruction algorithm on event detection signals generated by the detector modules of the detector array.
